(19) United States
(12) Patent Application Publication
(10) Pub. No.: US 2012/0139855 A1
(43) Pub. Date: Jun. 7, 2012

(54) APPARATUS AND METHOD FOR DETECTING TOUCH INFORMATION AND PROXIMITY INFORMATION IN DISPLAY APPARATUS

(75) Inventors: Sung Joo SUH, Seoul (KR); Chang Kyu Choi, Seongnam-si (KR); Kwon Ju Yi, Yongin-si (KR); Du Sik Park, Suwon-si (KR)

(73) Assignee: SAMSUNG ELECTRONICS CO., LTD., Suwon-si (KR)

(21) Appl. No.: 13/292,855

(22) Filed: Nov. 9, 2011

(30) Foreign Application Priority Data
Dec. 3, 2010 (KR) 10-2010-0122657

(51) Int. Cl. G06F 3/041

(52) U.S. Cl. 345/173

(57) ABSTRACT

Provided are an apparatus and method for detecting touch information and proximity information in a display apparatus. The apparatus for detecting the touch information and the proximity information in the display apparatus may detect the touch information and the proximity information by obtaining an image area associated with touch sensing and an image area associated with proximity sensing with respect to an obtained image in the display apparatus.

### CROSS-REFERENCE TO RELATED APPLICATIONS

This application claims the priority benefit of Korean Patent Application No. 10-2010-0122657, filed on Dec. 3, 2010, in the Korean Intellectual Property Office, the disclosure of which is incorporated herein by reference.

### BACKGROUND

1. Field

One or more example embodiments of the present disclosure relate to an apparatus for detecting touch information and proximity information by obtaining an image area associated with touch sensing and an image area associated with proximity sensing, with respect to an image obtained in a display apparatus.

2. Description of the Related Art

A display apparatus may provide an intuitive interface by supporting touch sensing technology.

As three-dimensional (3D) image technology has been developed, the display apparatus has provided proximity sensing technology to enable access to the 3D image, as well as the touch sensing technology.

When detecting a touch motion and a proximity motion of a user, the display apparatus may classify sensing information and touch information by obtaining an image with respect to motions of the user, and extracting a touch image area and a proximity image area.

However, the display apparatus may ambiguously classify the touch image area included in the image and the proximity image area, and it may therefore be difficult to extract the touch image area and the proximity area from the obtained image.

### SUMMARY

The foregoing and/or other aspects are achieved by providing an apparatus for detecting touch information and proximity information in a display apparatus, including an image extracting unit to extract a first image area associated with touch sensing using a first threshold, and to extract a second image area using a second threshold, with respect to an obtained image, and an image filtering unit to obtain a proximity image area associated with proximity sensing by removing an area associated with the first image area from the second image area.

The image extracting unit may extract the second image area using the second threshold, being relatively small compared to the first threshold.

The image filtering unit may remove, from the second image area, an area including the first image area as a part of the second image area.

The foregoing and/or other aspects are achieved by providing an apparatus for detecting touch information and proximity information in a display apparatus, including an image extracting unit to extract an image unit by sequentially applying different thresholds with respect to the image, and an image filtering unit to configure the extracted image unit based on a position in the image, and to classify the image unit as the first image area including a plurality of overlapped image units, and the second image area including a single image unit.

The image extracting unit may extract a touch image unit associated with touch sensing by applying a first threshold, and a proximity image unit associated with proximity sensing by applying a second threshold, being relatively small compared to the first threshold, and the image filtering unit may configure the touch image unit and the proximity image unit to be overlapped, and may classify the overlapped touch image unit and the overlapped proximity image unit into the first image area as a touch area.

The image filtering unit may configure a proximity image unit associated with the proximity sensing that may be extracted by applying the second threshold, being relatively small compared to the first threshold, and may classify the proximity image unit into the second image area as the proximity area, after applying the first threshold.

The foregoing and/or other aspects are achieved by providing a method for detecting touch information and proximity information in a display apparatus. The method includes extracting an image unit by sequentially applying different thresholds with respect to an obtained image, configuring the extracted image unit based on a position in the image and classifying the image unit as a first image area including a plurality of overlapped image units and a second image area including a single image unit, and performing, by way of a processor, at least one of a touch sensing operation and a proximity sensing operation based on the first image area and the second image area.

It is possible to easily detect touch information and proximity information by obtaining an image area associated with touch sensing, and an image area associated with proximity sensing, using a first threshold and a second threshold with respect to an image.

It is also possible to easily detect touch information and proximity information by extracting an image unit by sequentially applying different thresholds with respect to an image, by configuring the extracted image unit based on a position in the image, and by classifying the image unit into a first image area including a plurality of overlapped image units as a touch area, and a second image area including a single image unit as a proximity area.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates an example of a display apparatus according to example embodiments;

FIG. 2 illustrates an example of a configuration with respect to an apparatus for detecting touch information and proximity information in a display apparatus according to example embodiments;

FIG. 3 illustrates an example of an image obtained by an apparatus for detecting touch information and proximity information in a display apparatus according to example embodiments;

FIG. 4 illustrates another example of an image obtained by an apparatus for detecting touch information and proximity information in a display apparatus according to example embodiments;

FIG. 5 illustrates a flowchart of a method of detecting touch information and proximity information in a display apparatus according to example embodiments; and

FIG. 6 illustrates another flowchart of a method of detecting touch information and proximity information in a display apparatus according to example embodiments.

### DETAILED DESCRIPTION

Reference will now be made in detail to embodiments, examples of which are illustrated in the accompanying drawings, wherein like reference numerals refer to like elements throughout. Embodiments are described below to explain the present disclosure by referring to the figures.

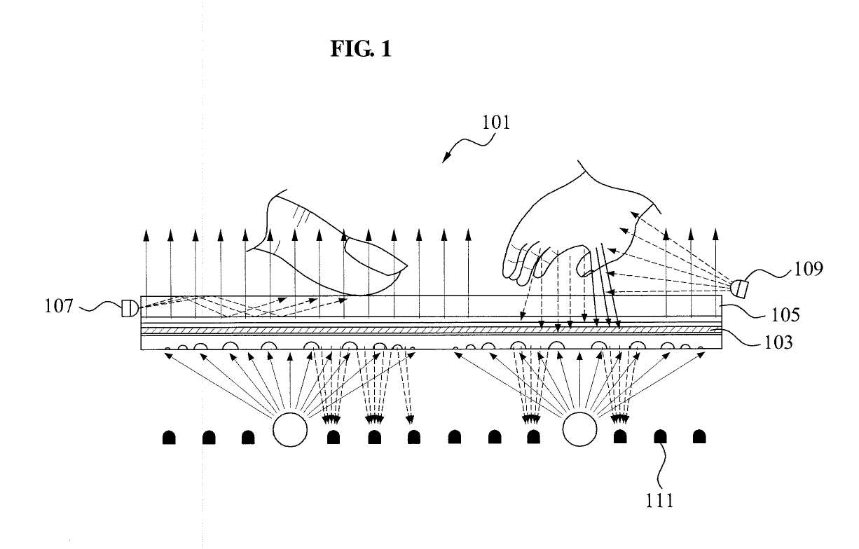

FIG. 1 illustrates an example of a display apparatus.

Referring to FIG. 1, a display apparatus 101 may be located in an upper part of a display panel 103, for example directly above or on top of the display panel 103, and may include, for example, an infrared (IR) light guide 105 to maintain an IR light inside by totally reflecting the IR, a touch IR light source unit 107 located on a side of the IR light guide 105, to emit a touch IR light source into the IR light guide 105, a Hover IR light source unit 109 located on another side such as an opposite side of the IR light guide 105, to emit a Hover IR light source onto a surface of the IR light guide 105, and an IR sensing unit 111 located in a lower part of the display panel 103, to sense the touch IR light source or the Hover IR light source that may be reflected from an object that may be touched or approached, on the IR light guide 105.

The display apparatus may obtain an image associated with at least one of touch sensing and proximity sensing, and may detect touch information and proximity information from the obtained image by sensing light from the touch IR light source or the Hover IR light source that is reflected from the object that may be touched or approached.

Here, the display apparatus may obtain the image associated with the touch sensing and the proximity sensing as a result of sensing light from the touch IR light source and the Hover IR light source by simultaneously activating the touch IR light source unit 107 and the Hover IR light source unit 109. In addition, the display apparatus may obtain a first image associated with the touch sensing as a result of sensing the touch IR light source, and then may obtain a second image associated with the proximity sensing as a result of sensing the Hover IR light source by sequentially activating the touch IR light source unit 107 and the Hover IR light source unit 109.

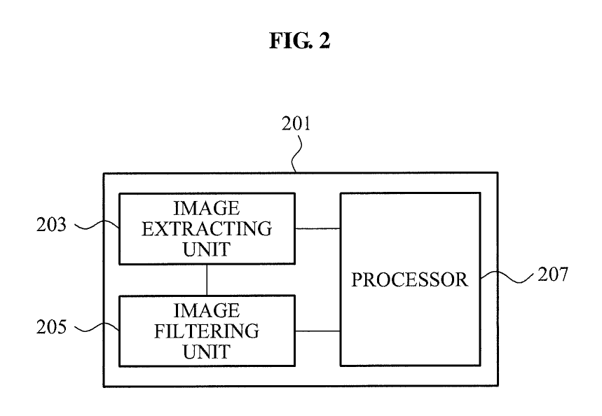

FIG. 2 illustrates an example of a configuration with respect to an apparatus for detecting touch information and proximity information in a display apparatus according to example embodiments.

Referring to FIG. 2, an apparatus 201 for detecting touch information and proximity information in a display apparatus may include, for example, an image extracting unit 203, an image filtering unit 205, and a processor 207.

The image extracting unit 203 may extract image areas using thresholds with respect to an obtained image. That is, the image extracting unit 203 may extract a first image area associated with touch sensing using a first threshold, and may extract a second image area using a second threshold, with respect to the obtained image. Here, the image may be obtained by a sensor panel in the display apparatus, in a state that a touch IR light source or a Hover IR light source is provided with respect to an image panel in the display apparatus.

For example, the image extracting unit 203 may extract, from the image, an area corresponding to a value greater than the first threshold as the first image area, and may extract, from the image, an area corresponding to a value greater than the second threshold as the second image area. Here, the second image area may include a proximity image area associated with the touch sensing as well as a proximity image area associated with the proximity sensing.

The image extracting unit 203 may extract the second image area using the second threshold, which may be relatively small compared to the first threshold. Here, the image extracting unit 203 may use the second threshold less than the first threshold in order to extract the second image area since brightness of the area associated with the proximity sensing may be lower than brightness of the area associated with the touch sensing. Accordingly, the second image area may include the first image area.

The image extracting unit 203 may extract the first image area and the second image area from a single image, and may also extract the first image area and the second image area from a plurality of images. For example, the image extracting unit 203 may extract the first image area from a first image obtained in association with the touch IR light source, and may extract the second image area from a second image obtained in association with the Hover IR light source.

The image extracting unit 203 may correct, for example, smooth the image, before extracting the first image area and the second image area from the image using the first threshold and the second threshold. Also, the image extracting unit 203 may apply filtering or segmentation used for extracting a touch point with respect to the first image area.

The image filtering unit 205 may obtain the proximity image area associated with the proximity sensing by removing an area associated with the first image area from the second image area. Particularly, the image filtering unit 205 may remove, from the second image area, an area including the first image area as a part of the second image area.

When the first image area and the second image area are extracted from the first image and the second image, the image filtering unit 205 may remove, from the second image area, an area corresponding to the first image area included as a part of the second image area, using a position of the first image area in the first image, and using a position of the second image area in the second image.

The processor 207 may perform an operation corresponding to the touch sensing by classifying the extracted first image area as the touch information. Also, the processor 207 may perform an operation corresponding to the proximity sensing by classifying the extracted proximity image area as the proximity information associated with the proximity sensing.

The apparatus for detecting the touch information and the proximity information in the display apparatus may easily classify the touch information associated with the touch sensing and the proximity information associated with the proximity sensing using the first threshold and the second threshold, even when the proximity image area associated with the touch sensing as well as the touch image area associated with the touch sensing and the proximity image area associated with the proximity sensing are included in the obtained image.

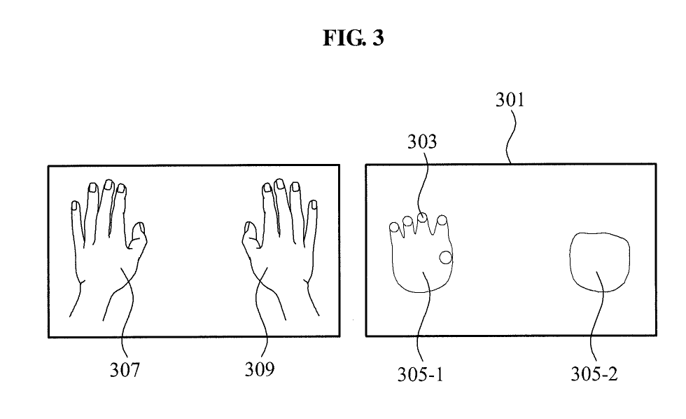

FIG. 3 illustrates an example of an image obtained by an apparatus for detecting touch information and proximity information in a display apparatus.

Referring to FIG. 3, an apparatus for detecting touch information and proximity information in a display apparatus may extract a first image area 303 associated with touch sensing using a first threshold with respect to an obtained image 301, and may extract second image areas 305-1 and 305-2 using a second threshold. Here, the image 301 may be obtained by sensing a touch motion of a first object 307 and a proximity motion of a second object 309 by a sensor panel in the display apparatus, in a state that a touch IR light source and a Hover IR light source are simultaneously provided in the display apparatus.

The apparatus for detecting the touch information and the proximity information in the display apparatus may obtain a proximity image area associated with proximity sensing by removing an area associated with the first image area from the second image area. For example, the apparatus for detecting the touch information and the proximity information in the display apparatus may obtain the proximity image area 305-2 associated with the proximity sensing, by removing from the second image areas 305-1 and 305-2, the area 305-1 including the first image area 303 as a part of the second image areas 305-1 and 305-2.

The apparatus for detecting the touch information and the proximity information in the display apparatus may perform an operation corresponding to the touch sensing by classifying the first image area 303 as the touch information, and may perform an operation corresponding to the proximity sensing by classifying the proximity image area 305-2 as the proximity information associated with the proximity sensing.

The apparatus for detecting the touch information and the proximity information in the display apparatus may limit the operation corresponding to the proximity sensing by classifying the area 305-1 including the first image area 303 as a part of the second image areas 305-1 and 305-2, as the proximity information associated with the touch sensing.

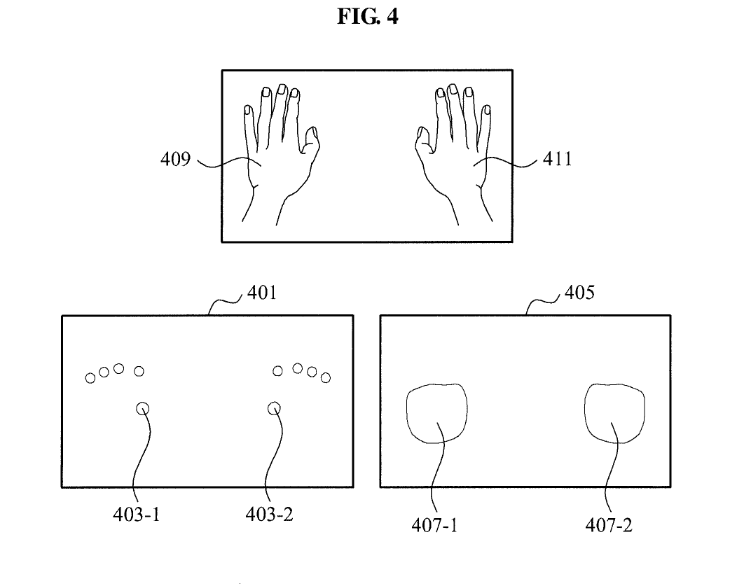

FIG. 4 illustrates another example of an image obtained by an apparatus for detecting touch information and proximity information in a display.

Referring to FIG. 4, an apparatus for detecting touch information and proximity information in a display apparatus may extract first image areas 403-1 and 403-2 from an obtained first image 401, and may extract second image areas 407-1 and 407-2 from an obtained second image 405.

Here, the first image 401 may be obtained by sensing a touch motion of a first object 409 and a touch motion of a second object 411 by a sensor panel in the display apparatus, in a state that a touch IR light source is provided in the display apparatus.

Also, the second image 405 may be obtained by sensing the touch motion of the first object 409 and the touch motion of the second object 411 by the sensor panel in the display apparatus, in a state that a Hover IR light source is provided in the display apparatus.

The apparatus for detecting the touch information and the proximity information in the display apparatus may remove, from the second image areas 407-1 and 407-2, areas 407-1 and 407-2 corresponding to the first image areas 403-1 and 403-2 included as a part of the second image areas 407-1 and 407-2, using positions of the first image areas in the first image 401, and using positions of the second image areas in the second image 405.

The apparatus for detecting the touch information and the proximity information in the display apparatus may perform an operation corresponding to touch sensing by classifying the first image areas 403-1 and 403-2 as the touch information.

However, the apparatus for detecting the touch information and the proximity information in the display apparatus may limit an operation corresponding to the proximity sensing by removing, from the second image areas 407-1 and 407-2, the areas 407-1 and 407-2 corresponding to the first image areas 403-1 and 403-2 included as a part of the second image areas 407-1 and 407-2, since the proximity image area associated with the touch sensing may be removed and thus the proximity information may not exist.

An apparatus for detecting touch information and proximity information in a display according to other example embodiments will be further described.

Referring back to FIG. 2, the apparatus 201 for detecting the touch information and the proximity information in the display apparatus may include, for example, the image extracting unit 203, an image filtering unit 205, and the processor 207.

The image extracting unit 203 may extract an image unit by sequentially applying different thresholds with respect to an image. The image extracting unit 203 may extract a touch image unit associated with touch sensing by applying a first threshold, and may extract a proximity image unit by applying a second threshold, being relatively small compared to the first threshold.

For example, the image extracting unit 203 may extract, from the image, a unit corresponding to a value greater than the first threshold as the touch image unit, and may extract, from the image, a unit corresponding to a value greater than the second threshold, being relatively small compared to the first threshold as the proximity image unit.

The image filtering unit 205 may configure the extracted image units based on positions in the image, and may classify the image units as a first image area including a plurality of overlapped image units, and a second image area including a single image unit.

Here, the image filtering unit 205 may configure the touch image unit and the proximity image unit to be overlapped, and may classify the overlapped touch image unit and the overlapped proximity image unit into the first image area as the touch area.

Also, the image filtering unit 205 may classify the second image area as the proximity area where the touch image unit is not overlapped to the proximity image unit.

The processor 207 may perform an operation corresponding to the touch sensing by identifying the first image area as the touch information. Also, the processor may perform an operation corresponding to proximity sensing by identifying the second image area as the proximity information associated with the proximity sensing.

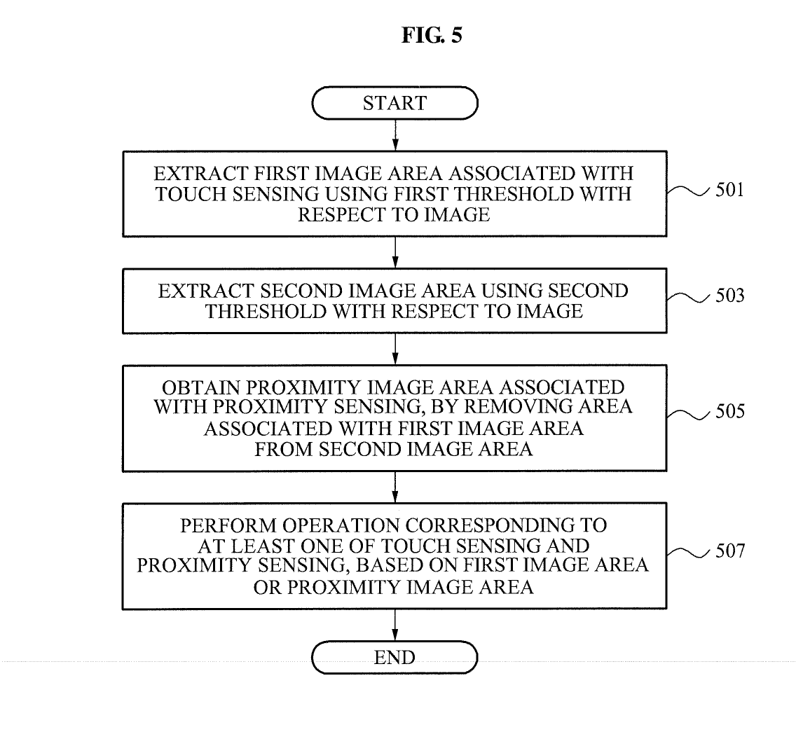

FIG. 5 illustrates a flowchart of a method of detecting touch information and proximity information in a display apparatus.

Referring to FIG. 5, an apparatus for detecting the touch information and the proximity information in the display apparatus may extract a first image area associated with touch sensing using a first threshold, with respect to an obtained image in operation 501.

Here, the apparatus for detecting the touch information and the proximity information in the display apparatus may obtain the image using a sensor panel in the display apparatus, in a configuration in which a touch IR light source or a Hover IR light source is provided with respect to an image panel in the display apparatus.

The apparatus for detecting the touch information and the proximity information in the display apparatus may extract, from the image, an area corresponding to a value greater than the first threshold as the first image area.

Also, the apparatus for detecting the touch information and the proximity information in the display apparatus may extract the first image area from the first image obtained in association with the touch IR light source.

The apparatus for detecting the touch information and the proximity information in the display apparatus may correct, for example, smooth the image before extracting the first image area from the image. Also, the apparatus for detecting the touch information and the proximity information in the display apparatus may apply filtering or segmentation used for extracting a touch point with respect to the first image area.

In operation 503, the apparatus for detecting the touch information and the proximity information in the display apparatus may extract the second image area using the second threshold with respect to the image. Here, the second threshold may be relatively small compared to the first threshold.

The apparatus for detecting the touch information and the proximity information in the display apparatus may extract, from the image, an area corresponding to a value greater than the second threshold as the second image area. Here, the second image area may include a proximity image area associated with touch sensing, as well as, a proximity image area associated with proximity sensing.

Also, the apparatus for detecting the touch information and the proximity information in the display apparatus may extract the second image area from the second image obtained in association with the Hover IR light source.

The apparatus for detecting the touch information and the proximity information in the display apparatus may extract the second image area using the second threshold.

In operation 505, the apparatus for detecting the touch information and the proximity information in the display apparatus may obtain the proximity image area associated with the proximity sensing by removing an area associated with the first image area from the second image area.

That is, the apparatus for detecting the touch information and the proximity information in the display apparatus may obtain the proximity image area associated with the proximity sensing by removing, from the second image area, an area including the first image area as a part of the second image area.

The apparatus for detecting the touch information and the proximity information in the display apparatus may obtain the proximity image area associated with the proximity sensing by removing, from the second image area, an area corresponding to the first image area included as a part of the second image area, based on a position of the first image area in the first image, and based on a position of the second image area in the second image.

In operation 507, the apparatus for detecting the touch information and the proximity information in the display apparatus may perform an operation corresponding to at least one of the touch sensing and the proximity sensing based on the first image area or the proximity image area.

The apparatus for detecting the touch information and the proximity information in the display apparatus may perform an operation corresponding to the touch sensing by classifying the extracted first image area as the touch information, and may perform an operation corresponding to the proximity sensing by classifying the extracted proximity image area as the proximity information associated with the proximity sensing.

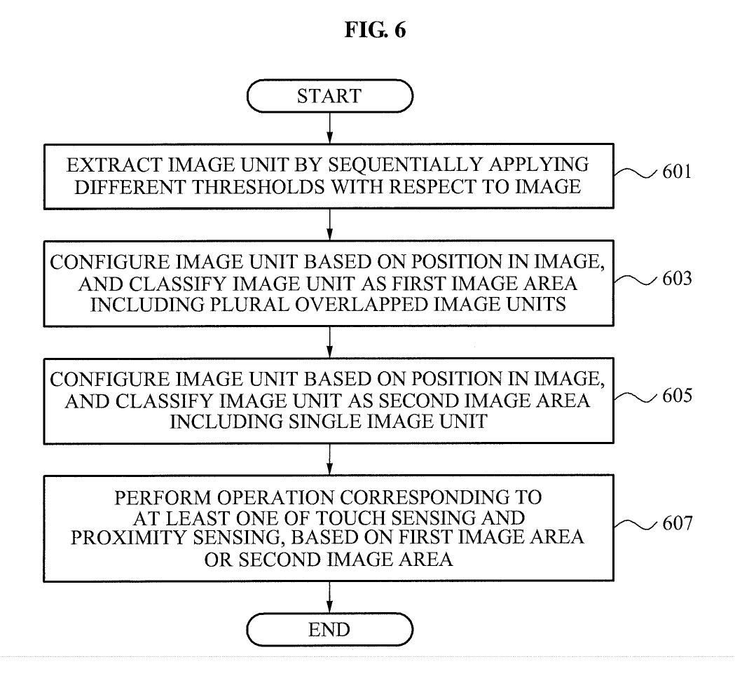

FIG. 6 illustrates a flowchart of a method of detecting touch information and proximity information in a display apparatus.

Referring to FIG. 6, an apparatus for detecting the touch information and the proximity information in the display apparatus may extract an image unit by sequentially applying different thresholds with respect to an image in operation 601.

The apparatus for detecting the touch information and the proximity information in the display apparatus may extract a touch image unit associated with touch sensing by applying a first threshold, and may extract a proximity image unit by applying a second threshold, which is relatively small compared to the first threshold.

For example, the apparatus for detecting the touch information and the proximity information in the display apparatus may extract, from the image, a unit corresponding to a value greater than the first threshold as the touch image unit, and may extract, from the image, a unit corresponding to a value greater than the second threshold as the proximity image unit.

In operation 603, the apparatus for detecting the touch information and the proximity information in the display apparatus may configure the extracted image units based on positions in the image, and may classify the image units as a first image area including a plurality of overlapped image units.

The apparatus for detecting the touch information and the proximity information in the display apparatus may configure the touch image unit and the proximity image unit to be overlapped, and may classify the overlapped touch image unit and the overlapped proximity image unit into the first image area as the touch area.

In operation 605, the apparatus for detecting the touch information and the proximity information in the display apparatus may configure the extracted image units based on positions in the image, and may classify the image units as the second image area including a single image unit.

The apparatus for detecting the touch information and the proximity information in the display apparatus may classify the second image area as the proximity area where the touch image unit does not overlap the proximity image unit.

In operation 607, the apparatus for detecting the touch information and the proximity information in the display apparatus may perform an operation corresponding to at least one of, the touch sensing and the proximity sensing based on the first image area and the second image area.

The apparatus for detecting the touch information and the proximity information in the display apparatus may perform an operation corresponding to the touch sensing by identifying the first image area as the touch information, or may perform an operation corresponding to the proximity sensing by identifying the second image area as the proximity information associated with the proximity sensing.

According to example embodiments, the touch information and the proximity information may be easily detected by obtaining the image area associated with the touch sensing, and the image area associated with the proximity sensing, using the first threshold and the second threshold, respectively.

According to example embodiments, the touch information and the proximity information may be easily detected by extracting the image unit by sequentially applying the different thresholds with respect to the image, and by configuring the extracted image unit based on a position in the image, by classifying the image unit into the first image area including a plurality of overlapped image units as a touch area, and by classifying the image unit into the second image area including a single image unit as a proximity area.

The method according to the above-described embodiments may be recorded in non-transitory computer-readable media or processor-readable media including program instructions to implement various operations embodied by a computer. The media may also include, alone or in combination with the program instructions, data files, data structures, and the like. The media and program instructions may be those specially designed and constructed for the purposes of the present disclosure, or they may be of the kind well-known and available to those having skill in the computer software arts.

Examples of computer-readable media or processor-readable media include: magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer or processor using an interpreter.

The described hardware devices may also be configured to act as one or more software modules or units in order to perform the operations of the above-described embodiments. The method of detecting touch information and proximity information in a display apparatus may be executed on a general purpose computer or processor or may be executed on a particular machine such as the apparatuses described herein. Any one or more of the software modules described herein may be executed by a dedicated processor unique to that unit or by a processor common to one or more of the modules.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. An apparatus for detecting touch information and proximity information in a display apparatus, the apparatus comprising:
a processor to control one or more processor-executable units;
an image extracting unit to extract a first image area associated with touch sensing using a first threshold and to extract a second image area using a second threshold, with respect to an obtained image; and
an image filtering unit to obtain a proximity image area associated with proximity sensing by removing an area associated with the first image area from the second image area.

2. The apparatus of claim 1, wherein the image extracting unit extracts the second image area using the second threshold, which is relatively small compared to the first threshold.

3. The apparatus of claim 1, wherein the image filtering unit removes, from the second image area, an area including the first image area as a part of the second image area.

4. The apparatus of claim 1, wherein the image is obtained by a sensor panel in the display apparatus, wherein a touch infrared (IR) light source or a Hover IR light source is provided with respect to an image panel in the display apparatus.

5. The apparatus of claim 4, wherein the image extracting unit extracts the first image area from a first image obtained in association with the touch IR light source, and extracts the second image area from a second image obtained in association with the Hover IR light source.

6. The apparatus of claim 5, wherein the image filtering unit removes, from the second image area, an area corresponding to the first image area that is included as a part of the second image area, using a position of the first image area and a position of the second image area.

7. An apparatus for detecting touch information and proximity information in a display apparatus, the apparatus comprising:
a processor to control one or more processor-executable units;
an image extracting unit to extract an image unit by sequentially applying different thresholds with respect to an obtained image; and
an image filtering unit to configure the extracted image unit based on a position in the image and to classify the image unit as a first image area including a plurality of overlapped image units and a second image area including a single image unit.

8. The apparatus of claim 7, wherein:
the image extracting unit extracts a touch image unit associated with touch sensing by applying a first threshold and a proximity image unit by applying a second threshold, which is relatively small compared to the first threshold; and
the image filtering unit configures the touch image unit and the proximity image unit to overlap and classifies the overlapped touch image unit and the overlapped proximity image unit into the first image area as a touch area.

9. The apparatus of claim 7, wherein:
the image extracting unit extracts a touch image unit associated with touch sensing by applying a first threshold and a proximity image unit by applying a second threshold, which is relatively small compared to the first threshold; and
the image filtering unit classifies the second image area as the proximity area to be configured without overlapping the touch image unit with the proximity image unit.

10. A method of detecting touch information and proximity information in a display apparatus, the method comprising:
extracting a first image area associated with touch sensing using a first threshold, with respect to an obtained image;
extracting a second image area using a second threshold, with respect to the obtained image; and
obtaining, by way of a processor, a proximity image area associated with proximity sensing by removing an area associated with the first image area from the second image area.

11. The method of claim 10, wherein the extracting of the second image area extracts the second image area using the second threshold, which is relatively small compared to the first threshold.

12. The method of claim 10, wherein the obtaining of the proximity image area includes obtaining the proximity image area associated with the proximity sensing by removing, from the second image area, an area including the first image area as a part of the second image area.

13. The method of claim 10, further comprising obtaining the image by a sensor panel in the display apparatus, wherein a touch infrared (IR) light source or a Hover IR light source is provided with respect to an image panel in the display apparatus.

14. The method of claim 13, wherein:
the extracting of the first image area comprises extracting the first image area from the first image obtained in association with the touch IR light source; and
the extracting of the second image area comprises extracting the second image area from the second image obtained in association with the Hover IR light source.

15. The method of claim 14, wherein the obtaining of the proximity image area comprises obtaining the proximity image area associated with the proximity sensing by removing, from the second image area, an area corresponding to the first image area that is included as a part of the second image area, using a position of the first image area and a position of the second image area.

16. A method for detecting touch information and proximity information in a display apparatus, the method comprising:
extracting an image unit by sequentially applying different thresholds with respect to an obtained image;
configuring the extracted image unit based on a position in the image and classifying the image unit as a first image area including a plurality of overlapped image units and a second image area including a single image unit; and
performing, by way of a processor, at least one of a touch sensing operation and a proximity sensing operation based on the first image area and the second image area.
